(19) United States
(12) Patent Application Publication
(10) Pub. No.: US 2007/0215470 A1
(43) Pub. Date: Sep. 20, 2007

(54) Gas concentration measuring apparatus designed to enhance response of sensor

(75) Inventors: Tomoo Kawase, Aichi-ken (JP); Mitsunobu Niwa, Kariya-shi (JP); Toshiyuki Suzuki, Handa-shi (JP); Satoshi Hada, Inazawa-shi (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/715,394

(22) Filed: Mar. 8, 2007

(30) Foreign Application Priority Data
Mar. 14, 2006 (JP) 2006-069011

(51) Int. Cl. G01N 27/26

(52) U.S. Cl. 204/424

(57) ABSTRACT

A gas concentration measuring apparatus is provided which may be employed in measuring the concentration of oxygen contained in exhaust emissions of automotive engines. The apparatus includes a gas sensor equipped with a solid electrolyte body and a pair of electrodes affixed to opposed surfaces of the solid electrolyte body. The apparatus includes an applied voltage controller which works to apply the voltage to the electrodes of the gas sensor to create an electric current as a function of a concentration of gas to be measured. The applied voltage controller is designed to have an enhanced gain of the voltage to the value of the current, as produced by the gas sensor, in a predetermined frequency band, thereby increasing the response of the gas sensor without inducing the oscillation of the voltage to be applied to the gas sensor.

### CROSS REFERENCE TO RELATED DOCUMENT

The present application claims the benefit of Japanese Patent Application No. 2006-69011 filed on Mar. 14, 2006, the disclosure of which is totally incorporated herein by reference.

### BACKGROUND OF THE INVENTION

1. Technical Field of the Invention

The present invention relates generally to a gas concentration measuring apparatus which may be used in measuring the concentration of a preselected component, such as oxygen, of exhaust emissions of automotive engines, and more particularly to such a gas concentration measuring apparatus designed to enhance the response of a sensor.

2. Background Art

O₂ sensors (also called A/F sensors) are known which are designed to measure the concentration of oxygen (O₂) contained in exhaust emissions of motor vehicle engines to determine an air-fuel (A/F) ratio of a mixture supplied to the engine. A typical one of the A/F sensors includes a sensor element made up of a solid electrolyte body and a pair of electrodes affixed to the solid electrolyte body. The measurement of concentration of oxygen is achieved by applying the voltage to the solid electrolyte body through the electrodes to produce a flow of electrical current through the sensor element as a function of the concentration of oxygen and sampling the electrical current to determine the concentration of oxygen.

Engine control ECUs (Electronic Control Units) work to monitor an output of the O₂ sensor to determine an actual value of air-fuel ratio of the mixture charged into the engine and bring it into agreement with a target value under feedback control. Usually, the O₂ sensor has a response lag arising from the time required by the exhaust gas to reach the sensor element and the time required by components of the gas to reach the electrodes of the sensor element. An increase in such a lag will result in a decrease in accuracy in determining the concentration of oxygen. This may lead to a decrease in accuracy of the feedback control of the air-fuel ratio of the mixture, thus degrading the quality of exhaust emissions of the engine.

In order to eliminate a variation in burning condition among cylinders of multi-cylinder internal combustion engines, the engine control ECU works to sample an output of the O₂ sensor for each cylinder of the engine to determine an actual value of the air-fuel ratio of the mixture charged into each cylinder and control the air-fuel ratio of the mixture to be injected subsequently into each cylinder under feedback control. Ensuring the accuracy in controlling the air-fuel ratio for each cylinder requires measuring the concentration of O₂ in the exhaust gas accurately. The response delay of the O₂ sensor, however, results in an error in determining a difference in air-fuel ratio among the cylinders of the engine, which will lead to a decrease in accuracy in controlling the air-fuel ratio for each cylinder.

In recent years, the breakage of the sensor element arising from the splashing with dew condensation water or flocculated water in the exhaust pipe of the engine has been acknowledged as a problem. In order to avoid this, an improved structure of a protective cover is proposed to minimize the splashing of the sensor element with water. The use of such a cover, however, encounters the drawback in that the cover will disturb the flow of the gas thereinto, thus resulting in a decrease in response rate of the O₂ sensor.

The decrease in accuracy in determining the concentration of oxygen due to the decrease in response rate of the O₂ sensor may be eliminated by improving either the mechanical structure of the O₂ sensor or the electrical structure of a sensor controller to increase the response rate thereof. The improvement of the mechanical structure of the O₂ sensor, however, has still left a difficulty in addressing the time lag of the response of the O₂ sensor arising from the time consumed by the gas to reach the sensor element. Accordingly, the ensuring of the accuracy in determining the concentration of oxygen requires improvement of the response rate of the sensor controller.

Usually, the concentration of O₂ in the exhaust gas of the engine changes at a frequency of, for example, 5 Hz to 10 Hz depending upon running conditions of the engine. The voltage to be applied to the sensor element is typically determined as a function of an instant value of the current flowing through the sensor element. Specifically, the sensor controller works to sample the instant value of the sensor current, select a target level as a function of the sampled value, and bring the voltage to be applied to the sensor element to the target level without deviating a limiting current range. The improvement of the accuracy of the output of the sensor element may, thus, be achieved by turning the control of the voltage to be applied to the sensor element. For example, Japanese Patent First Publication No. 2000-81413 teaches improved techniques for controlling the voltage to be applied to the sensor element. However, increasing the gain of the sensor controller to determine the voltage to be applied to the sensor element in response to the output of the sensor element may cause a total gain that is the sum of the gain of the sensor element and the gain of the sensor controller to exceed one (1), thereby resulting in oscillation of the sensor applied voltage.

### SUMMARY OF THE INVENTION

It is therefore a principal object of the invention to avoid the disadvantages of the prior art.

It is another object of the invention to provide a gas concentration measuring apparatus designed to enhance the response of a gas sensor without inducing the oscillation of voltage to be applied to the gas sensor.

According to one aspect of the invention, there is provided a gas concentration measuring apparatus which may be employed in determining an air-fuel ratio of an automotive engine for use in air-fuel ratio control. The gas concentration measuring apparatus comprises: (a) a gas concentration sensor which includes a solid electrolyte body and a pair of electrodes affixed to opposed surfaces of the solid electrolyte body, the gas concentration sensor being responsive to application of voltage to the electrodes to produce a sensor current that is an electric current as a function of a concentration of a selected component of gas; (b) a current measuring circuit working to measure the sensor current, as produced by the gas concentration sensor; and (c) an applied voltage controller working to change the voltage to be applied to the gas concentration sensor as a function of a value of the sensor current, as measured by the current measuring circuit. The applied voltage controller is designed to have an enhanced gain of the voltage to the value of the sensor current in a given frequency band.

When the total gain of a combination of the sensor element and the applied voltage controller exceeds one (1), it will result in oscillation of the voltage to be applied to the sensor element. The frequency characteristics of the applied voltage controller are, thus, defined to eliminate such oscillation. For example, in the case where the sensor element is equipped with a solid electrolyte layer, it has high-pass filter characteristics as frequency characteristics. The total gain of the sensor element and the applied voltage controller may thus be kept below one (1) by designing the applied voltage controller to have low-pass filter characteristics, thereby avoiding the oscillation of the voltage to be applied to the sensor element.

The applied voltage controller is, as described above, designed to have the enhanced gain in the desired frequency band, thereby enabling the response of the sensor element to be enhanced without inducing the oscillation of the voltage to be applied to the sensor element.

In the preferred mode of the invention, the applied voltage controller has a low-pass filter circuit installed at an output stage thereof from which the voltage is outputted and applied to the gas concentration sensor. The low-pass filter is designed to have a dual filter structure, thereby delimiting the given frequency range clearly.

The cut-off frequency of the low-pass filter circuit may be approximately 10 Hz.

The applied voltage controller may alternatively have a band-pass filter installed at the output stage thereof from which the voltage is outputted and applied to the gas concentration sensor. The band-pass filter may have a low-frequency side cut-off frequency of approximately 1 Hz and a high-frequency side cut-off frequency of approximately 5 Hz.

The applied voltage controller has a current path through which an electric current that is a function of the sensor current flows. The applied voltage controller may also include a capacitor connected in parallel to the current path. In this case, the applied voltage controller may preferably include a parallel circuit which is made of the capacitor and a resistor connected to the capacitor in parallel and connected in series with the current path, so that the parallel circuit serves as a high-pass filter whose cut-off frequency is approximately 5 Hz.

According to another aspect of the invention, there is provided a gas concentration measuring apparatus which comprises: (a) a gas concentration sensor which includes a solid electrolyte body and a pair of electrodes affixed to opposed surfaces of the solid electrolyte body, the gas concentration sensor being responsive to application of voltage to the electrodes to produce a sensor current that is an electric current as a function of a concentration of a selected component of gas; (b) a current measuring circuit working to measure the sensor current, as produced by the gas concentration sensor, to output a gas concentration signal representing the concentration of the selected component of the gas; and (c) a differential amplifier installed at an output stage of the current measuring circuit from which the gas concentration signal is outputted. The differential amplifier is designed to have an enhanced gain of output of the gas concentration signal in a given frequency band.

In the preferred mode of the invention, the current measuring circuit includes an input resistor leading to an input of the differential amplifier and a series circuit connected in parallel to the input resistor. The series circuit is made up of a capacitor and a resistor which are connected in series to serve as a high-pass filter whose cut-off frequency is approximately 1 Hz.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a circuit diagram which shows an electric structure of a sensor control circuit of a gas concentration measuring apparatus according to the invention;

FIG. 2 is a transverse sectional view which shows a sensor element used in the gas concentration measuring apparatus as illustrated in FIG. 1;

FIG. 3 shows an example of an applied voltage-to-output current map for use in determining a target voltage to be applied to the sensor element as illustrated in FIG. 2;

FIG. 4 is a graph which shows frequency characteristics of a sensor element, a sensor control circuit, and a combination thereof;

FIG. 5 is a graph which shows changes in gain of output of two types of sensors;

FIG. 6 is a graph which shows increases in gain of frequency characteristics of a sensor control circuit, and a combination of a sensor element and the sensor control circuit;

FIG. 7 is a circuit diagram which shows the first modification of a sensor control circuit of a gas concentration measuring apparatus;

FIG. 8(a) is a graph which shows increases in gain of frequency characteristics of the sensor control circuit, as illustrated in FIG. 7, and a combination of a sensor element and the sensor control circuit;

FIG. 8(b) is a graph which shows an increase in level of an output of a sensor current meter of the sensor control circuit representing the current, as produced by the sensor element in FIG. 7;

FIG. 9 is a circuit diagram which shows the second modification of a sensor control circuit of a gas concentration measuring apparatus;

FIG. 10 is a circuit diagram which shows the third modification of a sensor control circuit of a gas concentration measuring apparatus;

FIG. 11(a) is a graph which shows increases in gain of an output of a sensor current meter of the sensor control circuit, as illustrated in FIG. 10; and

FIG. 11(b) is a graph which shows an increase in level of an output of the sensor current meter of the sensor control circuit representing the current, as produced by the sensor element in FIG. 10.

### DESCRIPTION OF THE PREFERRED EMBODIMENTS

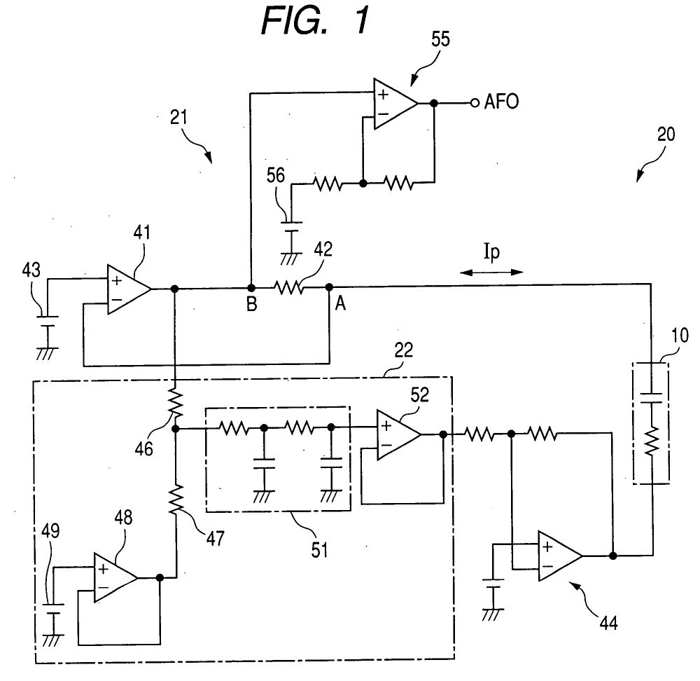

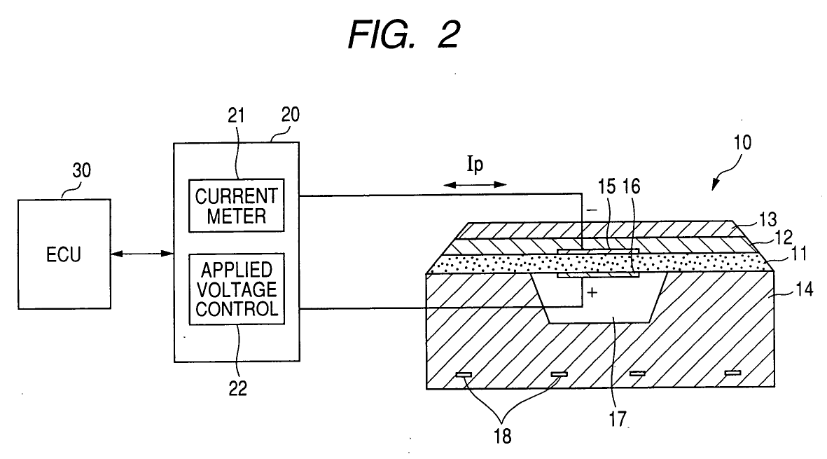

Referring to the drawings, wherein like reference numbers refer to like parts in several views, particularly to FIGS. 1 and 2, there is shown a gas concentration measuring apparatus designed to measure the concentration of oxygen (O₂) contained in exhaust emissions of an automotive engine which corresponds to an air-fuel ratio of a mixture supplied to the engine. The measured concentration is used in an air-fuel ratio control system implemented by an engine electronic control unit (ECU). The air-fuel ratio control system works to perform a stoichiometric burning control to regulate the air-fuel ratio of the mixture around the stoichiometric air-fuel ratio under feedback control and a lean-burn control to bring the air-fuel ratio to within a given lean range under feedback control.

The gas concentration measuring apparatus, as illustrated in FIG. 2, includes a sensor control circuit 20, an electronic control unit (ECU) 30, and an oxygen sensor (will be referred to as an air-fuel (A/F) sensor below) which works to produce a current signal as a function of concentration of oxygen contained in exhaust emissions introduced into a gas chamber formed in the A/F sensor.

The A/F sensor includes a laminated sensor element 10 which has a sectional structure, as illustrated in FIG. 2. The sensor element 10 has a length extending perpendicular to the drawing surface of FIG. 2 and is, in practice, disposed within a sensor housing at a base portion thereof and a protective cover at a top portion thereof. The A/F sensor is installed in an exhaust pipe of the engine. For instance, EPO 987 546 A2, assigned to the same assignee as that of this application teaches a structure and control of an operation of this type of gas sensor in detail, disclosure of which is incorporated herein by reference.

The sensor element 10 is made up of a solid electrolyte layer 11, a diffusion resistance layer 12, a shielding layer 13, and an insulating layer 14 which are laminated vertically as viewed in the drawing. The sensor element 10 is surrounded by a protective layer (not shown). The solid electrolyte layer 11 is made of a rectangular partially-stabilized zirconia sheet and has upper and lower electrodes 15 and 16 affixed to opposed surfaces thereof. The electrodes 15 and 16 are made of platinum (Pt), for example. The diffusion resistance layer 12 is made of a porous sheet which permits exhaust gasses to flow to the electrode 15. The shielding layer 13 is made of a dense sheet which inhibits the exhaust gasses from passing therethrough. The layers 12 and 13 are each formed using a sheet made of ceramic such as alumina or zirconia and have average porosities, or gas permeability different from each other.

The insulating layer 14 is made of ceramic such as alumina or zirconia and has formed therein an air duct 17 to which the electrode 16 is exposed. The insulating layer 14 has a heater 18 embedded therein. The heater 18 is made of heating wire which is supplied with power from a storage battery installed in the vehicle to produce heat the whole of the sensor element up to a desired activation temperature. In the following discussion, the electrode 15 will also be referred to as a diffusion resistance layer side electrode, and the electrode 16 will also be referred to as an atmosphere side electrode. The atmosphere side electrode 16 is connected to a positive (+) terminal of a power source, while the diffusion resistance layer side electrode 15 is connected to a negative (−) terminal of the power source.

The exhaust gasses flowing within an exhaust pipe of the engine to which the sensor element 10 is exposed enter and pass through the side of the diffusion resistance layer 12 and reach the electrode 15. When the exhaust gasses are in a fuel lean state (more oxygen), oxygen molecules contained in the exhaust gasses are decomposed or ionized by application of voltage between the electrodes 15 and 16, so that they are discharged to the air duct 17 through the solid electrolyte layer 11 and the electrode 16. This will cause a positive current to flow from the atmosphere side electrode 16 to the diffusion resistance layer side electrode 15. Alternatively, when the exhaust gasses are in a fuel rich state (less oxygen), oxygen molecules contained in air within the air duct 17 are ionized by the electrode 16 so that they are discharged into the exhaust pipe through the solid electrolyte layer 11 and the electrode 15 and undergo catalytic reaction with unburned components such as HC, CO, or H₂ in the exhaust gasses. This will cause a negative current to flow from the diffusion resistance layer side electrode 15 to the atmosphere side electrode 16.

The electrodes 15 and 16 are connected to the sensor control circuit 20. The sensor control circuit 20 is equipped with a sensor current meter 21 and an applied voltage controller 22. The sensor current meter 21 works to measure the electric current, as described above, flowing through the sensor element 10 through a resistor. The current flowing through the sensor element 10 will also be referred to as sensor current below. The sensor current meter 21 also works to output a gas concentration indicative signal to the ECU 30 in the form of an A/F output voltage AFO. The applied voltage controller 22 works to control the level of voltage to be applied to the sensor element 10 as a function of an instant value of the sensor current, as measured by the sensor current meter 21.

Although not illustrated for the sake of simplicity, the sensor control circuit 20 is also equipped with an impedance detector to measure the impedance (i.e., an internal resistance) of the sensor element 10 and a heater controller. For example, the impedance detector works to sweep the voltage applied to the sensor element 10 instantaneously in an ac form to calculate the impedance thereof (which will also be referred to as sensor element impedance below) using a resulting change in current flowing through the sensor element 10. The heater controller works to control the energization of the heater 18 to keep the temperature of the sensor element 10 at a selected value, thereby placing the sensor element 10 at an activated state.

The sensor control circuit 20 is connected to the ECU 30. The ECU 30 is made of a known arithmetic logic unit such as a microcomputer and works to sample the gas concentration indicative signal (i.e., the A/F output voltage AFO), as outputted from the sensor control circuit 20, to calculate the value of an A/F ratio of the mixture. The ECU 30 also works to use the value of the A/F ratio in the air-fuel ratio feedback control. Specifically, the ECU 30 calculates a target value of the A/F ratio for each cylinder of the engine and determines a target quantity of fuel to be injected into each cylinder to control an actual amount of fuel injected into each cylinder under feedback control.

In use, the A/F sensor equipped with the sensor element 10 is, as described above, installed in the exhaust pipe of the engine. The top end portion of the A/F sensor exposed to the exhaust emissions in the exhaust pipe is embraced by a protective cover having a double walled structure to avoid splashing the sensor element 10 with water, thereby minimizing the breakage of the sensor element 10 arising from the splashing with dew condensation water or flocculated water in the exhaust pipe.

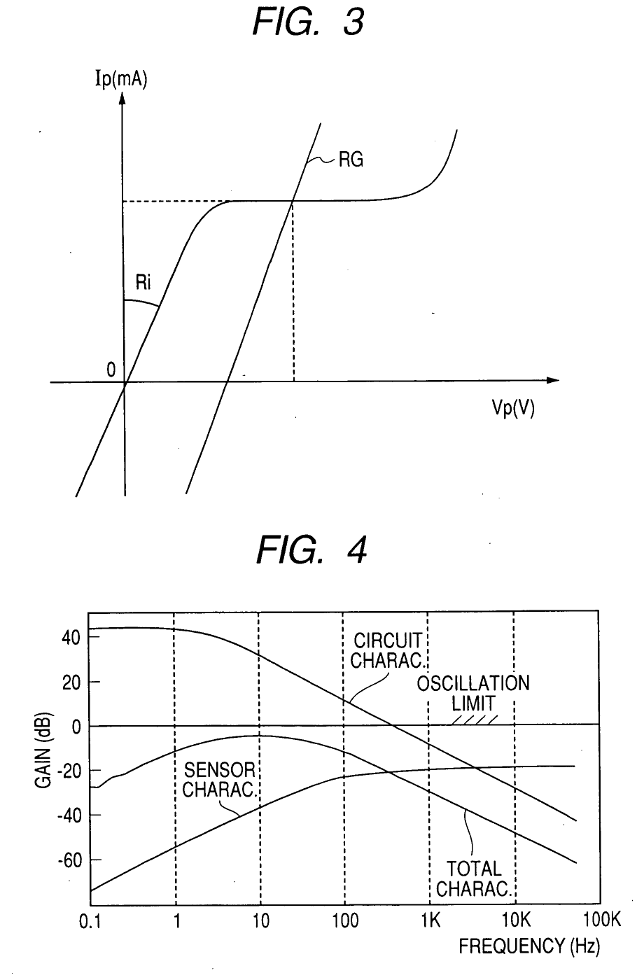

FIG. 3 shows a voltage-to-current relation (i.e., V-I characteristic) of the A/F sensor. A straight segment of a V-I curve extending parallel to the abscissa axis (i.e., V-axis) indicate a limiting current range within which the sensor element 10 produces an electric current Ip (i.e., a limiting current) as a function of an air-fuel ratio (i.e., richness or leanness). Specifically, as the air-fuel ratio changes to the lean side, the current Ip produced by the sensor element 10 increases, while as the air-fuel ratio changes to the rich side, the current Ip decreases. The current Ip will also be referred to as a sensor current below.

A portion of the V-I curve lower in voltage than the limiting current range is a resistance-dependent range. An inclination of a first-order segment of the V-I curve depends upon dc internal resistance Ri of the sensor element 10. The dc internal resistance Ri changes with a change in temperature of the sensor element 10. Specifically, it increases with a decrease in temperature of the sensor element 10, so that the inclination of the first-order segment of the V-I curve in the resistance-dependent range is decreased. Alternatively, when the temperature of the sensor element 10 rises, it results in a decrease in the dc internal resistance Ri, so that the inclination of the first-order segment of V-I curve is increased. A line RG indicates a target voltage Vp to be applied to the sensor element 10 (i.e., the electrodes 15 and 16).

The applied voltage controller 22, as described above, works to monitor an instant value of the sensor current Ip, select the target voltage Vp along the line RG as a function of the sensor current Ip, and move the voltage to be applied to the sensor element 10 to the target voltage Vp without deviating the limiting current range. Usually, the concentration of O₂ in the exhaust gas of the engine (i.e., the sensor current Ip) changes at a frequency of, for example, 5 Hz to 10 Hz depending upon running conditions of the engine. The applied voltage controller 22, thus, works to calculate the target voltage Vp cyclically in response to the frequency of the sensor current Ip.

In the above applied voltage control, the sensor element 10 may be expressed by a series circuit made up of a resistance component and a capacitive component. The frequency characteristics (i.e., sensor characteristics) of the sensor element 10 include high-pass filter (HPF) characteristics. Usually, when the sum of a sensor gain of the sensor element 10 and a circuit gain of the sensor control circuit 20 exceeds one (1), it will cause the voltage applied to the sensor element 10 to oscillate. In order to suppress such oscillation, the frequency characteristics (i.e., circuit characteristics) of the sensor control circuit 20 are designed to have LPF characteristics. The sum of the sensor characteristics and the circuit characteristics will be referred to as total characteristics below. The suppression of the oscillation of the voltage applied to the sensor element 10 is achieved by selecting the gain of the total characteristics to be lower than the limit (i.e., one (1)) which will induce the oscillation of the applied voltage.

FIG. 4 demonstrates frequency characteristics of the sensor element 10, the sensor control circuit 20 and a combination of the sensor element 10 and the sensor control circuit 20 (i.e., the sensor characteristics, the circuit characteristics, and the total characteristics). The sensor characteristics have, as described above, the HPF characteristics, while the circuit characteristics have the LPF characteristics, thereby adjusting the gain of the total characteristics (i.e., the gain of a combination of the sensor control circuit 20 and the sensor element 10) below the oscillation limit (i.e., 1).

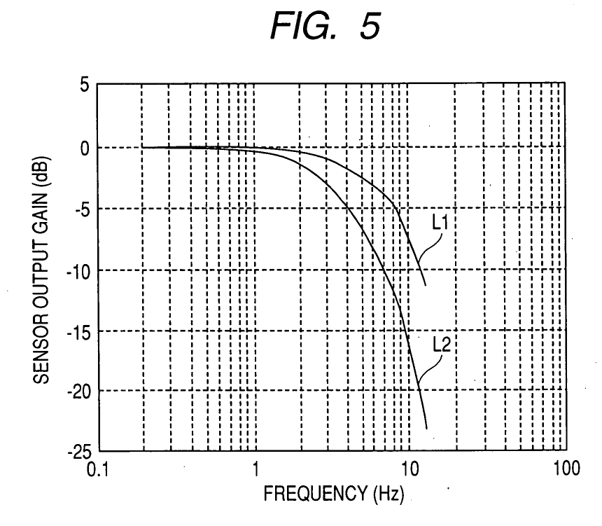

FIG. 5 is a graph which demonstrates frequency characteristics of outputs of two types of A/F sensors. The line L1 indicates a change in gain of the output of the A/F sensor equipped with a normal protective cover in terms of a change in frequency of the voltage applied thereto. Similarly, the line L2 indicates a change in gain of the output of the A/F sensor equipped with a double-walled protective cover or anti-splashing protective cover designed to minimize the splashing of the sensor element 10 with water.

The graph shows that the response rate (i.e., the amplitude gain of the output) of either of the A/F sensors drops in a frequency band higher than 1 Hz, and that a drop in gain of one of the A/F sensors equipped with the anti-splashing protective cover (i.e., L2) is greater than that of the other A/F sensor equipped with the normal protective cover (i.e., L1).

The sensor control circuit 20 is, as will be described later in detail, designed to have a low-pass filter (LPF) assembly installed at an output stage of the applied voltage controller 22. The LPF assembly is made up of a plurality of LPFs to enhance the gain of the voltage to be applied to the sensor element 10 in a desired frequency band, e.g., 1 Hz to 5 Hz which is within a typical frequency band (i.e., the frequency of the concentration of O₂ in the exhaust gas) below the oscillation limit in the sensor control circuit 20 and, as illustrated in FIG. 4, in which a greater interval exists between the gain of the total characteristics and the oscillation limit. The use of the plurality of LPFs results in an increased degree of attenuation in the transition-band between the pass-band and the stop-band which bounds the cut-off frequency, thus facilitating ease of defining the gain-increasing frequency band below the oscillation limit.

Referring to FIG. 1, the sensor control circuit 20 includes an operational amplifier 41, a current-measuring resistor 42, a reference power supply 43, and a differential amplifier 44. The reference power supply 43 is joined to one of ends of the sensor element 10 through the operational amplifier 41 and the current-measuring resistor 42. The applied voltage controller 22 is connected to the other end of the sensor element 10 through the differential amplifier 44. The voltage appearing at a junction A leading to one of ends of the current-measuring resistor 42 is kept at the same level as the reference voltage (e.g., 2.2V) of the reference power supply 43. The sensor current Ip flows through the current-measuring resistor 42 so that the voltage appearing at a junction B changes with a change in the sensor current Ip.

The applied voltage controller 22 works to monitor the voltage at the junction B and determine the target voltage Vp to be applied to the sensor element 10 as a function of the monitored voltage, for example, by look-up using the target applying voltage line RG, as illustrated in FIG. 3.

Specifically, the applied voltage controller 22 include a series resistance circuit made up of resistors 46 and 47 connected in series with the junction B, an operational amplifier 48, and a reference power supply 49. The operational amplifier 48 and the reference power supply 49 are connected in series with the series resistance circuit. The applied voltage controller 22 also includes an LPF circuit 51 and an operational amplifier 52 which are connected in series with a junction between the resistors 46 and 47. The LPF circuit 51 is made up of two sets of resistors and capacitors. Specifically, the LPF circuit 51 is made up of two LPFs and has a cut-off frequency of about 10 Hz. The two LPFs may have the same cut-off frequency or cut-off frequencies different from each other.

The sensor current meter 21 includes a differential amplifier 55 and a reference power supply 56. The differential amplifier 55 is connected to the junction B and has a given amplification factor. The differential amplifier 55 works to amplify a difference in voltage between the junction B and the reference power supply 56 and output it as the A/F output voltage AFO to the ECU 30.

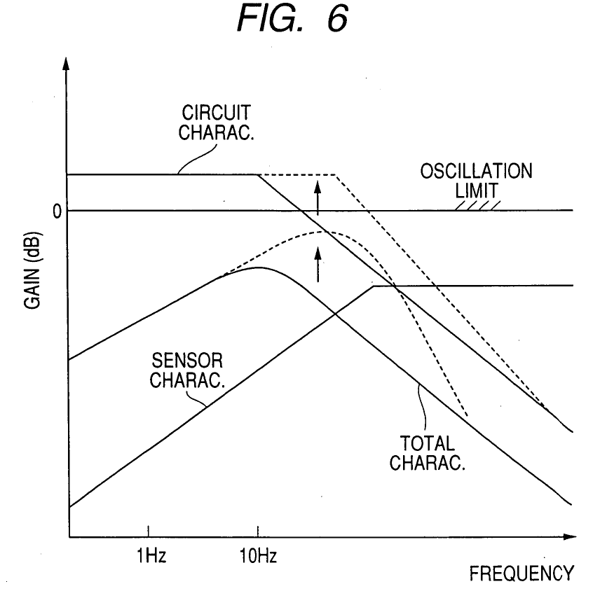

FIG. 6 illustrates an example of frequency characteristics, i.e., the sensor characteristics, the circuit characteristics, and the total characteristics which may be obtained when the LPF circuit 51 is made up of the two LPFs. Broken lines indicate increases in gain, as provided by the LPF circuit 51 having the dual-filter structure.

The graph shows that the use of the dual-filter structure of the LPF circuit 51 enables the gain of the circuit characteristics to be increased above approximately 5 Hz, thus resulting in an increase in gain of the total characteristics in a frequency band around 10 Hz which is within the typical frequency band of the output of the sensor element 10.

The LPF circuit 51 of the applied voltage controller 22 is, as described above, designed to have the dual-filter structure to increase the gain of the voltage to be applied to the sensor element 10 in a desired limited frequency band, thereby ensuring the quick response of the output from the sensor element 10 without inducing the oscillation of the voltage applied to the sensor element 10. The increase in the gain of the voltage to be applied to the sensor element 10 will results in a decrease in inclination of the V-I curve because a ratio of a change in voltage to be applied to the sensor element 10 to a change in the sensor current Ip is changed becomes great. Specifically, the applied voltage controller 22 works to change the voltage to be applied to the sensor element 10 greatly in response to a smaller change in the sensor current Ip. The sensor current Ip is, thus, subjected to a quick change tailing the change in voltage applied to the sensor element 10, that is, responds to such a change in voltage at high speed apparently (i.e., a hunting mode). This results in improved accuracy in measuring the concentration of O₂ contained in exhaust emissions of the engine and in the feedback control of the air-fuel ratio. Particularly, in the case of the air-fuel ratio of the mixture is controlled in each of the cylinders of the engine independently, the structure of the applied voltage controller 22 serves to minimize undesirable smoothing of the concentration of O₂ arising from mixing of exhaust gas emitted from one of the cylinders with that from another of the cylinders between the engine and a portion of the exhaust pipe in which the A/F sensor is installed, thus enhancing the accuracy in correcting a variation in combustion among the cylinders.

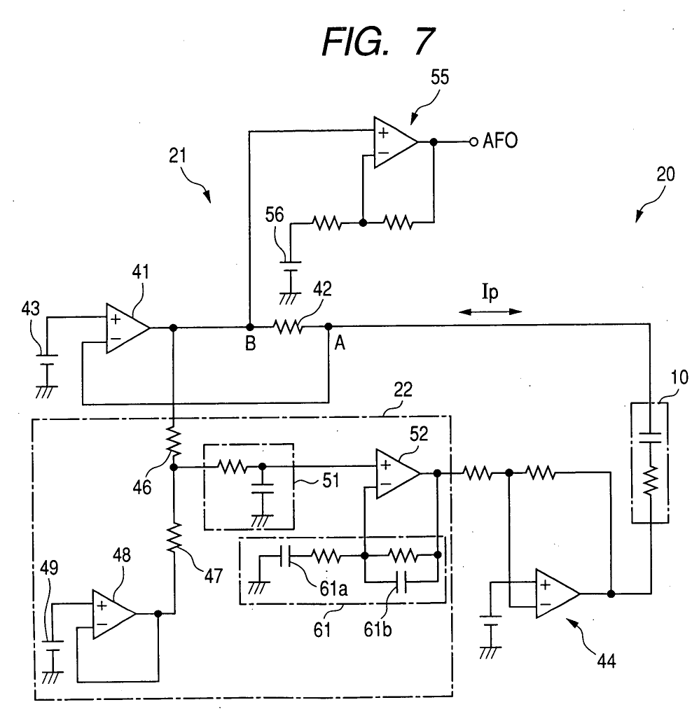

FIG. 7 shows a modification of the sensor control circuit 20.

The LPF circuit 51 is designed to have a typical single filter structure. The applied voltage controller 22 also includes a bandpass filter (BPF) circuit 61 connected to the operational amplifier 52. The bandpass filter circuit 61 is made up of a HPF 61a and a LPF 61b. The cut-off frequency of the HPF 61a is about 1 Hz. The cut-off frequency of the LPF 61b is the about 5 Hz.

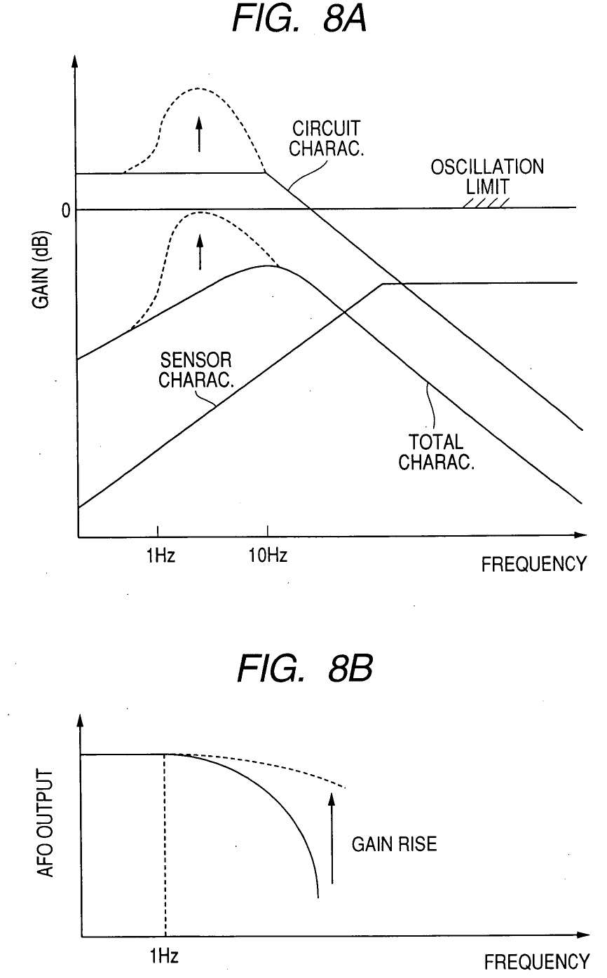

FIG. 8(a) is a graph which shows frequency characteristics, i.e., the sensor characteristics, the circuit characteristics, and the total characteristics in the structure of FIG. 7. Broken lines, like FIG. 4, indicate increases in gain, as provided by the dual-filter structure of the bandpass filter circuit 61.

Specifically, the bandpass filter 61 works to increase the gain of the frequency characteristics of the sensor control circuit 20 in a frequency band higher than 1 Hz while keeping the total gain below one (1) to increase the gain of the total characteristics in a typical sensor output frequency band of about 1 Hz to 5 Hz. FIG. 8(b) shows an increase in gain of the A/F output voltage AFO, as provided by the bandpass filter 61.

Other arrangements are identical with those in FIG. 1, and explanation thereof in detail will be omitted here.

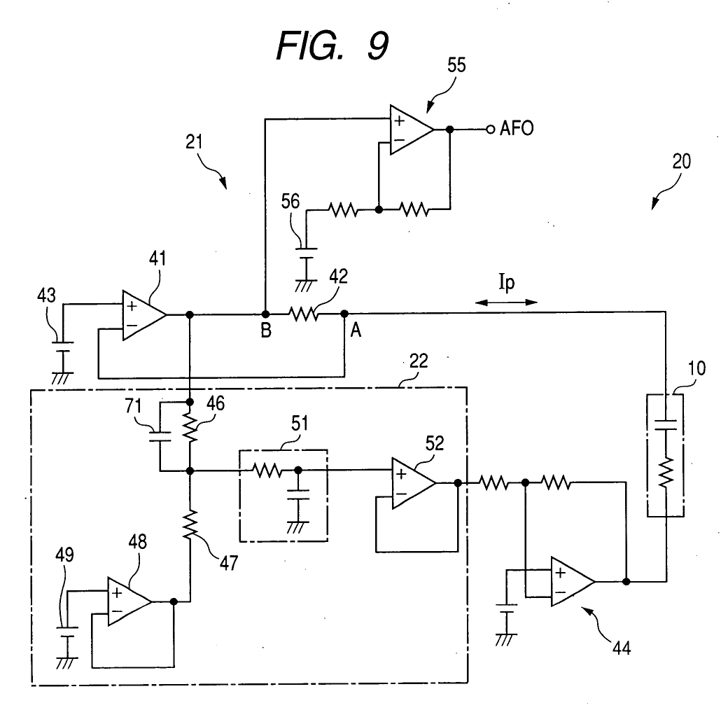

FIG. 9 shows the second modification of the sensor control circuit 20.

The LPF circuit 51 is designed to have a typical single filter structure. The applied voltage controller 22 also includes a capacitor 71 connected in parallel to the resistor 46 which leads to the junction B at which the sensor current Ip is measured. The resistor 46 and the capacitor 71 form a HPF whose cut-off frequency is about 5 Hz.

The structure of this modification, like in FIG. 7, works to increase the gain of the frequency characteristics of the sensor control circuit 20 in a frequency band higher than 1 Hz while keeping the total gain below one (1) to increase the gain of the total characteristics within a typical sensor output frequency band of about 1 Hz to 5 Hz.

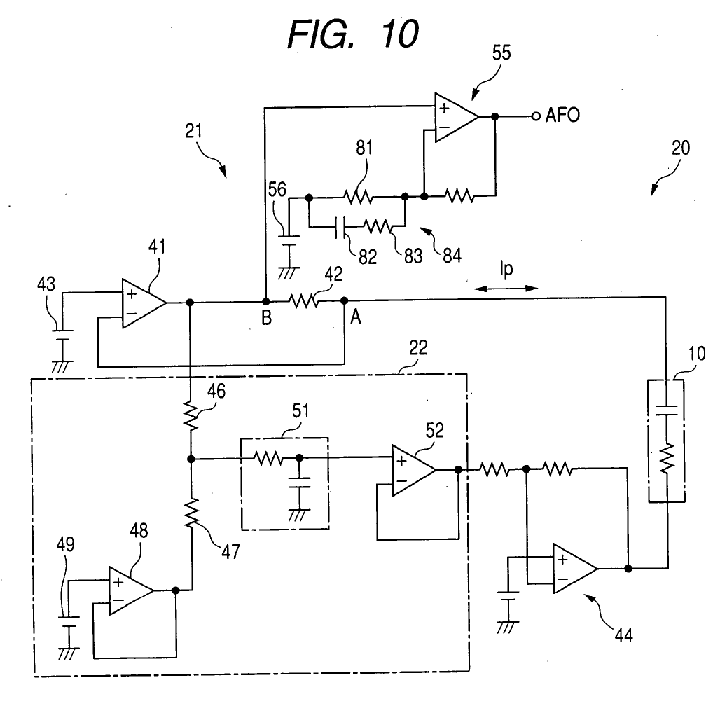

FIG. 10 shows the third modification of the sensor control circuit 20. The LPF circuit 51 of the applied voltage controller 22 is designed to have a typical single filter structure. Other arrangements of the applied voltage controller 22 are identical with those in FIG. 1. The sensor current meter 21 works to enhance the gain of output of the A/F output voltage AFO.

Specifically, the sensor current meter 21 includes a HPF 84 made up of a capacitor 82 and a resistor 83 which are connected in series in parallel to the input resistor 81 of the differential amplifier 55. The cut-off frequency of the HPF 84 is about 1 Hz.

In operation, when the sensor current Ip changes at lower frequencies, a flow of electric current to the capacitor 82 is blocked, so that most of the current passes through the input resistor 81. Alternatively, when the sensor current Ip changes at higher frequencies, the current flows both through the input resistor 81 and the series circuit of the capacitor 82 and the resistor 83. Therefore, the current flowing from the reference power supply 56 into the differential amplifier 55 undergoes a decreased resistance (i.e., an effective resistance of the resistors 81 and 83), thus resulting in an increase in gain of the differential amplifier 55 in a high-frequency band.

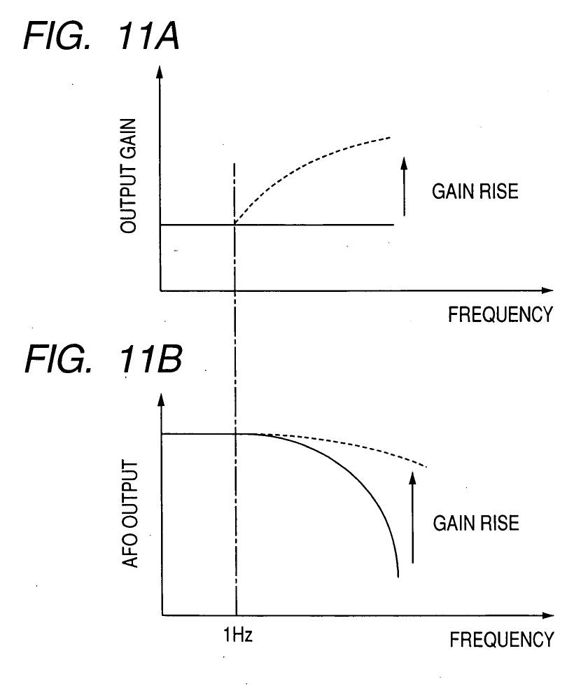

FIG. 11(a) is a graph which demonstrates frequency characteristics of the structure of the sensor controller 20 in FIG. 10. A broken line indicates an increase in gain of the sensor current meter 21. FIG. 11(b) is a graph which demonstrates the A/F output voltage AFO, as outputted from the sensor current meter 21. A broken line indicates an increase in output level of the A/F output voltage AFO. The graph shows that the gain of the A/F output voltage AFO is increased in a high-frequency range greater than 1 Hz, thereby enhancing the response of output of the A/F sensor to improve the accuracy in determining the concentration of oxygen (O₂) contained in exhaust emissions of the engine.

The sensor element 10 of the A/F sensor may alternatively be designed to have two or three solid electrode layers or may be made to have a cup-shaped structure.

The gas concentration measuring apparatus, as described in each of the above embodiments, may be used with a composite gas concentration measuring sensor which includes first and second cells made of a solid electrolyte body. The first cell works as a pump cell to pump oxygen molecules out of or into a first gas chamber formed in a sensor body and output a signal indicative of the concentration of the pumped oxygen molecules. The second cell works as a sensor cell to produce a signal indicative of the concentration of a preselected component of gasses flowing into a second gas chamber from the first gas chamber. For example, the composite gas concentration measuring sensor may be used to measure the concentration NOx contained in exhaust gasses of the automotive engine. Further, the composite gas concentration measuring sensor may be designed to have a third cell serving as a monitor cell or a second pump cell to produce an electromotive force as a function of concentration of oxygen molecules remaining in the second gas chamber.

The gas concentration measuring apparatus may alternatively be designed to measure the concentration of HC or CO contained in the exhaust gasses of the automotive engine. The measurement of concentration of HC or CO is achieved by pumping excessive oxygen (O₂) out of the first gas chamber using the pump cell and decomposing HC or CO contained in the gasses entering the second gas chamber using the sensor cell to produce an electric signal indicative of the concentration of HC or CO.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas concentration measuring apparatus comprising:
a gas concentration sensor which includes a solid electrolyte body and a pair of electrodes affixed to opposed surfaces of the solid electrolyte body, said gas concentration sensor being responsive to application of voltage to the electrodes to produce a sensor current that is an electric current as a function of a concentration of a selected component of gas;
a current measuring circuit working to measure the sensor current, as produced by said gas concentration sensor; and
an applied voltage controller working to change the voltage to be applied to said gas concentration sensor as a function of a value of the sensor current, as measured by said current measuring circuit, said applied voltage controller being designed to have an enhanced gain of the voltage to the value of the sensor current in a given frequency band.

2. A gas concentration measuring apparatus as set forth in claim 1, wherein said applied voltage controller has a low-pass filter circuit installed at an output stage thereof from which the voltage is outputted and applied to said gas concentration sensor, the low-pass filter being designed to have a dual filter structure.

3. A gas concentration measuring apparatus as set forth in claim 2, wherein a cut-off frequency of the low-pass filter circuit is approximately 10 Hz.

4. A gas concentration measuring apparatus as set forth in claim 1, wherein said applied voltage controller has a band-pass filter installed at an output stage thereof from which the voltage is outputted and applied to said gas concentration sensor.

5. A gas concentration measuring apparatus as set forth in claim 4, wherein the band-pass filter has a low-frequency side cut-off frequency of approximately 1 Hz and a high-frequency side cut-off frequency of approximately 5 Hz.

6. A gas concentration measuring apparatus as set forth in claim 1, wherein said applied voltage controller has a current path through which an electric current that is a function of the sensor current flows, said applied voltage controller also including a capacitor connected in parallel to the current path.

7. A gas concentration measuring apparatus as set forth in claim 6, wherein said applied voltage controller includes a parallel circuit which is made of the capacitor and a resistor connected to the capacitor in parallel and connected in series with the current path, and wherein the parallel circuit serves as a high-pass filter whose cut-off frequency is approximately 5 Hz.

8. A gas concentration measuring apparatus comprising:
a gas concentration sensor which includes a solid electrolyte body and a pair of electrodes affixed to opposed surfaces of the solid electrolyte body, said gas concentration sensor being responsive to application of voltage to the electrodes to produce a sensor current that is an electric current as a function of a concentration of a selected component of gas;
a current measuring circuit working to measure the sensor current, as produced by said gas concentration sensor, to output a gas concentration signal representing the concentration of the selected component of the gas; and
a differential amplifier installed at an output stage of said current measuring circuit from which the gas concentration signal is outputted, said differential amplifier being designed to have an enhanced gain of output of the gas concentration signal in a given frequency band.

9. A gas concentration measuring apparatus as set forth in claim 8, wherein said current measuring circuit includes an input resistor leading to an input of said differential amplifier and a series circuit connected in parallel to the input resistor, the series circuit being made up of a capacitor and a resistor which are connected in series.

10. A gas concentration measuring apparatus as set forth in claim 9, wherein the series circuit serves as a high-pass filter whose cut-off frequency is approximately 1 Hz.
